(19) United States
(12) Patent Application Publication
(10) Pub. No.: US 2026/0260126 A1
(43) Pub. Date: Sep. 3, 2026

(54) SYSTEM AND METHOD FOR TRAINING AN EMBEDDINGS CACHE MODEL (ECM)

(71) Applicants: Constructor Technology AG, Schaffhausen (CH); Constructor Education and Research Genossenschaft, Schaffhausen (CH)

(72) Inventors: Sergey ULASEN, Singapore (SG); Alexander TORMASOV, Busingen am Hochrhein (DE); Laurent DEDENIS, Geneve (CH); Stanislav PROTASOV, Singapore (SG); Serg BELL, Singapore (SG); Nikolay DOBROVOLSKIY, Alanya (TR)

(21) Appl. No.: 19/066,236

(22) Filed: Feb. 28, 2025

(51) Int. Cl. G06N 3/096; G06F 40/40

(52) U.S. Cl. CPC G06N 3/096; G06F 40/40

(57) ABSTRACT

Disclosed herein are systems and methods for training an embeddings cache model (ECM). The method includes generating a main embedding by a main embedding model based on a received input query. The method also includes searching for the input query or the generated main embedding in a cache table. Based on a determination that the input query is not found in the cache table and the main embedding is not found in the cache table within the embedding similarity threshold, the method further includes: based on a determination that the number of entries in the cache table is equal to or greater than the predetermined threshold for training the ECM, storing the input query and the main embedding in the cache table, and training or fine-tuning the ECM based on the input query and the main embedding, and transmitting the main embedding to the LLM service.

### FIELD OF TECHNOLOGY

The present disclosure relates to the field of machine learning models (MLMs), and, more specifically, to systems and methods for training an embeddings cache model (ECM).

### BACKGROUND

Embeddings are utilized by large language models (LLMs) to provide a foundational way to represent language in a dense, continuous, and semantically rich vector space. These embeddings encode the relationships between words, phrases, or even entire documents, enabling LLMs to capture the nuances of meaning and context. By transforming discrete linguistic elements into mathematical representations, embeddings allow LLMs to perform complex tasks like understanding synonyms, polysemy, and contextual variations efficiently.

### SUMMARY

LLM embedding generation solutions may be expensive, slow, unreliable, and generally not accurate. The present disclosure describes a system and method for generating custom embeddings using an embeddings cache model (ECM) for custom large language models (LLMs). Some of the technical improvements include generating custom embeddings for the LLM for different subject matters or for customer-specific embeddings based on business data of a customer. These custom LLM embeddings allow higher accuracy of LLM queries and better accuracy of LLM responses. Another technical improvement is increased system reliability since continuous operation ensures that the system continues functioning even when the main embedding model is unavailable, avoiding complete service disruption.

In one exemplary aspect, a method for training an embeddings cache model (ECM) for custom large language models (LLM) is disclosed. In some aspects, the techniques described herein relate to a method, further comprising: receiving an input query to a large language model (LLM) service from a user; generating a main embedding by a main embedding model based on the input query; searching for the input query or the generated main embedding in a cache table; based on a determination that the input query is found in the cache table, transmitting a corresponding main embedding associated with the found input query to the LLM service; based on a determination that the main embedding is found in the cache table within an embedding similarity threshold, transmitting the main embedding to the LLM service; based on a determination that the input query is not found in the cache table and the main embedding is not found in the cache table within the embedding similarity threshold, based on a determination that a number of entries in the cache table is less than a predetermined threshold for training the ECM, storing the input query and the main embedding as corresponding entries in the cache table, based on a determination that the number of entries in the cache table is equal to or greater than the predetermined threshold for training the ECM, storing the input query and the main embedding in the cache table and training or fine-tuning the ECM based on the input query and the main embedding, and transmitting the main embedding to the LLM service.

In some aspects, the techniques described herein relate to a method, wherein the cache table comprises: at least a first column having input queries, a second column having main embeddings generated from the main embedding model, and a third column having cache embeddings generated from the ECM.

In some aspects, the techniques described herein relate to a method, wherein determining whether the input query is found in the cache table further comprises: searching the cache table for the input query using a LLM, and determining that the input query is found in the cache table within a query similarity threshold.

In some aspects, the techniques described herein relate to a method, wherein the embedding similarity threshold is determined based on a similarity metric between distances of two or more embedding vectors.

In some aspects, the techniques described herein relate to a method, wherein the cache table comprises a plurality of cache tables such that each cache table comprises custom embeddings associated with a respective subject matter.

In some aspects, the techniques described herein relate to a method, wherein determining whether the input query is found in the cache table further comprises: identifying a subject matter corresponding to the input query, selecting a respective cache table associated with the subject matter, and determining whether the input query is found in the selected cache table associated with the subject matter for the input query.

In some aspects, the techniques described herein relate to a method, wherein determining whether the main embedding corresponds to an embedding in the cache table further comprises: identifying a subject matter corresponding to the input query; selecting a respective cache table associated with the subject matter; and determining whether the custom embeddings associated with the subject matter for the input query are stored in the cache table within the embedding similarity threshold.

In some aspects, the techniques described herein relate to a method, further comprising: generating one or more questions corresponding to the input query; prompting the user, via a user interface, with the one or more questions; obtaining main embeddings from main embeddings model for one or more answers from the user; and storing the one or more answers from the user and the corresponding main embeddings in the cache table.

In some aspects, the techniques described herein relate to a method, the method further comprising: training the ECM by: obtaining a plurality of input queries to the LLM service; obtaining corresponding main embeddings for the input query from the LLM service; and training the ECM to generate embeddings using knowledge distillation based on the plurality of input queries and the corresponding main embeddings.

In some aspects, the techniques described herein relate to a method, further comprising: determining whether a user is authorized to access the cache table, wherein the cache table is accessible to authorized users only.

According to one aspect of the disclosure, a system is provided for training an ECM for LLMs is disclosed, the system including: at least one memory; and at least one hardware processor coupled with the at least one memory and configured, individually or in combination, to: receive an input query to a large language model (LLM) service from a user; generate a main embedding by a main embedding model based on the input query; search for the input query or the generated main embedding in a cache table; based on a determination that the input query is found in the cache table, transmit a corresponding main embedding associated with the found input query to the LLM service; based on a determination that the main embedding is found in the cache table within an embedding similarity threshold, transmit the main embedding to the LLM service; based on a determination that the input query is not found in the cache table and the main embedding is not found in the cache table within the embedding similarity threshold, based on a determination that a number of entries in the cache table is less than a predetermined threshold for training the ECM, store the input query and the main embedding as corresponding entries in the cache table, and based on a determination that the number of entries in the cache table is equal to or greater than the predetermined threshold for training the ECM, store the input query and the main embedding in the cache table and train or fine-tune the ECM based on the input query and the main embedding, and transmit the main embedding to the LLM service.

In one exemplary aspect, a non-transitory computer-readable medium is provided storing a set of instructions thereon for training an embeddings cache model (ECM), the system, including instructions for: receiving an input query to a large language model (LLM) service from a user; generating a main embedding by a main embedding model based on the input query; searching for the input query or the generated main embedding in a cache table; based on a determination that the input query is found in the cache table, transmitting a corresponding main embedding associated with the found input query to the LLM service; based on a determination that the main embedding is found in the cache table within an embedding similarity threshold, transmitting the main embedding to the LLM service; based on a determination that the input query is not found in the cache table and the main embedding is not found in the cache table within the embedding similarity threshold, based on a determination that a number of entries in the cache table is less than a predetermined threshold for training the ECM, storing the input query and the main embedding as corresponding entries in the cache table, based on a determination that the number of entries in the cache table is equal to or greater than the predetermined threshold for training the ECM, storing the input query and the main embedding in the cache table and training or fine-tuning the ECM based on the input query and the main embedding, and transmitting the main embedding to the LLM service.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1a is a block diagram illustrating a distributed system illustrating several users associated with an enterprise network according to aspects of the present disclosure.

FIG. 1b is a system diagram illustrating a block diagram for improving an embeddings cache model (ECM) for custom large language models (LLMs), according to aspects of the present disclosure.

FIG. 2 is a block diagram illustrating a system for executing a main embedding model while training the ECM according to aspects of the present disclosure.

FIG. 3 is a block diagram illustrating a system for executing the EMC to generate custom embeddings when the main embedding model is unavailable according to aspects of the present disclosure.

FIG. 4 is a block diagram illustrating a system for providing additional information for training the EMC according to aspects of the present disclosure.

FIG. 5 is an example of a local cache table according to aspects of the present disclosure.

FIG. 6 is an example method of generating custom LLM embeddings according to aspects of the present disclosure.

FIG. 7 is an example method of training an ECM according to aspects of the present disclosure.

FIG. 8 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for generating custom Large Language Model (LLM) embeddings using an Embedding Cache Model (ECM). Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

LLM embeddings leverage dense vector representations to capture semantic relationships between words, phrases, or entire texts. These embeddings can be clustered to group similar concepts, allowing for efficient organization and retrieval of information. One of the key advantages of embeddings is their ability to reduce the dimensionality of language data while preserving its semantic structure. Traditional representations, like one-hot encodings, are sparse and computationally expensive, offering no insight into the relationships between different words. In contrast, embeddings cluster semantically similar items closer together, enabling LLMs to generalize and infer relationships across vast datasets. This compact representation not only saves computational resources but also enhances the model's ability to learn patterns and context effectively.

The key features of embeddings are dimensionality reduction, semantic similarity, and efficiency. The embeddings map high-dimensional data (e.g., sparse word counts, pixels) into lower-dimensional space, preserving important features. Semantic similarity refers to having similar items being closer in the semantic space. Embeddings enable efficient computation for downstream tasks (e.g., clustering, classification). Simply put, embeddings are foundational in modern artificial intelligence (AI), transforming raw data into structured representations that facilitate a wide range of machine learning tasks.

Embeddings also play a pivotal role in enabling LLMs to handle a wide range of tasks. For instance, embeddings empower LLMs to perform semantic search, recommendation, and clustering by leveraging vector similarity measures. They are equally indispensable for cross-lingual and multimodal applications, aligning language with other modalities like images or audio in a shared vector space. Pretrained embeddings further accelerate model training and transfer learning, providing a strong baseline of linguistic knowledge that can be fine-tuned for specific applications or domains.

Custom embeddings for LLMs are particularly valuable when dealing with domain-specific tasks or datasets because custom embeddings enable a model to better understand and represent the unique vocabulary, nuances, and relationships inherent to a specialized field. While general-purpose LLMs are trained on diverse datasets to provide broad applicability, their embeddings may not capture the subtle contextual meanings of terms within specific domains, such as medicine, law, or finance. Custom embeddings, derived from domain-specific data, enhance the model's ability to process specialized terminology and context, leading to improved task performance and relevance. This is especially critical for applications like semantic search, classification, or question answering, where precision is paramount. Moreover, custom embeddings ensure the model aligns closely with proprietary or sensitive data, improving accuracy and efficiency while respecting the unique requirements of the domain. By tailoring embeddings, organizations can unlock the full potential of LLMs for their specific use cases.

Similar embodiments for generating embeddings with LLMs often face challenges related to cost, speed, accuracy, or accessibility. For instance, widely used models such as Open AI's embedding services can be prohibitively expensive for users requiring frequent or large-scale embedding generation. Additionally, technical limitations may make these models inaccessible in certain environments, further complicating their use. The generic nature of many embedding solutions can also fall short when users require highly precise, domain-specific embeddings tailored to specialized tasks. In such cases, relying solely on a main embedding model is impractical, prompting a need for a more efficient, cost-effective, and customizable solutions that provides faster generation of embeddings while delivering accuracy aligned with the user's specific requirements.

Accordingly, the present disclosure describes implementing an ECM for generating custom LLM embeddings tailored to unique needs, enabling higher precision, and improved performance in data processing and model responses. By embedding data more effectively and with a specified purpose, LLMs gain a deeper understanding of the underlying information, resulting in more accurate queries and responses. The present disclosure begins with the preparation of input data and/or queries (e.g., text, spectrograms, digital audio, images, videos). The input data and/or queries is tokenized to break it down into manageable units, which are then transformed into embeddings. These embeddings may be dense numerical vectors containing 500 to 8,000 numbers per vector. These embeddings encapsulate the essential features and relationships within the data, which serves as a robust foundation for enhanced LLM performance across a range of applications.

Turning now to the figures, example aspects are depicted with reference to one or more components described herein, where components in dashed lines may be optional.

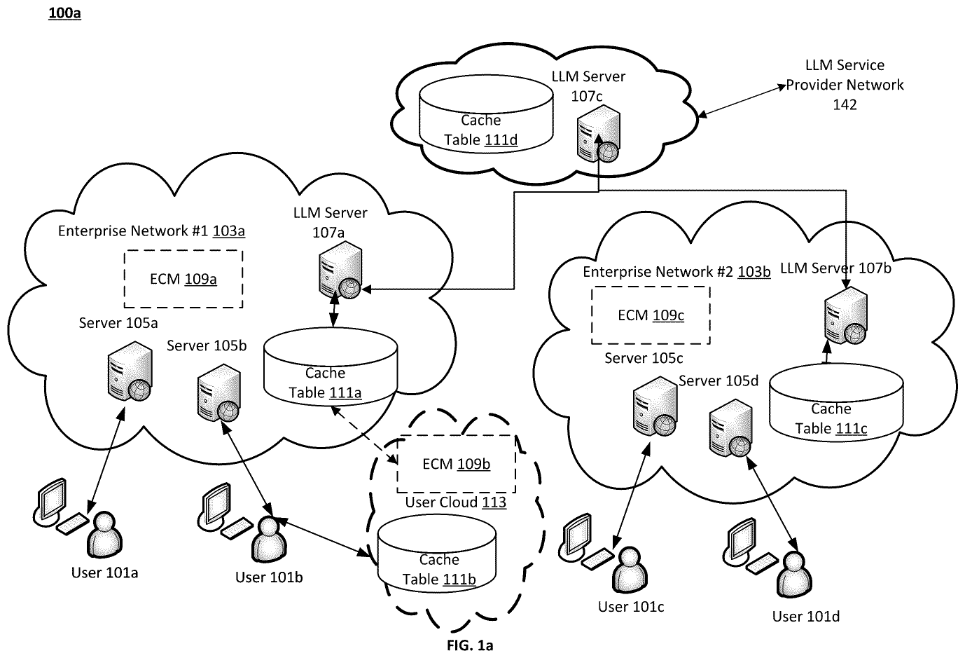

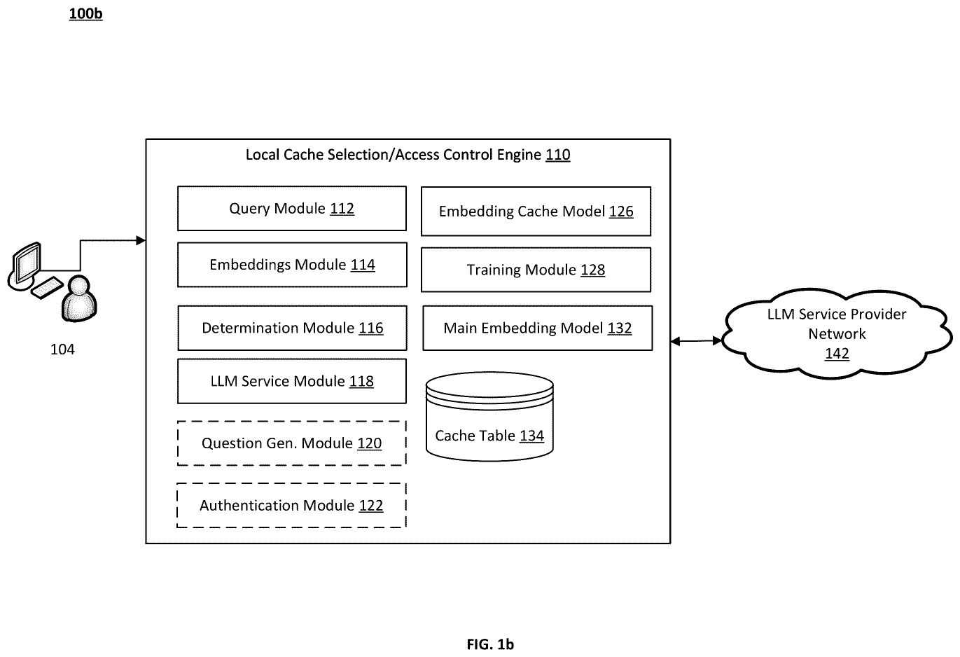

FIG. 1a is a block diagram illustrating a distributed system 100a illustrating several users associated with an enterprise network according to aspects of the present disclosure. The distributed system 100a is for a scenario in which the enterprise network accesses LLM functionality from a service provider (e.g., cloud serve provider).

In one aspect, the distributed system 100a includes a first enterprise network 103a which includes servers 105a, 105b, an optional embedding cache model (ECM) 109a, a LLM server 107a, and a local embedding cache table 111a (e.g., cache table), a second enterprise network 103b which includes servers 105c, 105d, an optional ECM 109c, a LLM server 107b, and a cache table 111c, a LLM server 107c which includes a cache table 111d, and a user cloud 113.

In some aspects, the ECMs 109a, 109b, 109c may be smaller, faster, cheaper, and more precise than the main embedding model. Accordingly, if the main embedding model on the LLM server 107c is not accessible, the cache tables 111a, 111b, 111c, 111d store replicated data (e.g., input and output) from the main embedding model on the LLM servers.

The cache table may be placed in several different locations of the distributed system 100a. In some aspects, the cache table 111d may be common to the LLM server 107c. In some aspects, the cache table 111b may be placed on the user cloud 113. In some aspects, the cache tables 111a, 111b may be placed on the first and second enterprise networks 103a, 103b. In some aspects, the cache tables 111a, 111b may be placed on the enterprise networks 103a, 103b along with merging cache from several users.

A local cache table may be a data structure or storage system used to store embeddings and associated metadata locally for efficient retrieval and usage. In the context of LLM embeddings, it serves as a repository for embedding vectors that represent pieces of data (e.g., text, images, or other content) in a high-dimensional space. By enabling quick lookups without the need to recompute embeddings or make repeated remote API calls, a local cache table can significantly reduce latency, which is critical for real-time applications like chatbots, recommendation systems, and semantic search. Additionally, it helps save costs by avoiding redundant embedding computations and enhances scalability by storing only the most relevant or frequently accessed embeddings. Local cache tables also improve data privacy by keeping sensitive embeddings on-premises, minimizing reliance on external servers. They can store metadata alongside embeddings, making it easier to manage relationships between the vectors and their source data, such as document IDs or timestamps. Implemented using key-value stores, vector databases, or in-memory structures, local cache tables are essential for improving the performance, scalability, and privacy of applications relying on LLM embeddings.

Users 101a, 101b, 101c, 101d of the first enterprise network 103a and the second enterprise network 103b (e.g., employees or customers) communicate with devices in the first enterprise network 103a and the second enterprise network 103b via one of the servers 105a, 105b and servers 105c, 105d, respectively. For example, user 101a communicates with components of the first enterprise network 103a via server 105a.

The first enterprise network 103a and the second enterprise network 103b are communicatively coupled to an LLM service provider network 142 for accessing LLM functionalities. The LLM of the present disclosure is implemented on the LLM service provider network 142. The LLM of the present disclosure is implemented on the server 107c located in the LLM service provider network 142.

To enable enterprise employees to use the LLM services to intelligently search and query data files and documents stored in the enterprise database, in one exemplary aspect, the LLM server 107c may be configured to operate on data of the first enterprise network 103a and the second enterprise network 103b. Particularly, in one aspect, the LLM server 107c may be configured to perform LLM training, LLM fine-tuning, and LLM inference (and any other required operations) using the data.

FIG. 1b is a system diagram illustrating a block diagram for improving an embeddings cache model (ECM) for custom large language models (LLMs), according to aspects of the present disclosure.

The system 100b may be used to implement a ECM 126 for custom LLMs. Generally, the local cache selection/access control engine 110 is configured to prepare the ECM 126 and to generate custom embeddings using the prepared ECM 126 when a main embedding model 132 is not accessible. Embeddings are powerful tools for generating vector representations of textual, visual, or multimodal data. These models map inputs (e.g., text, images, or other data types) into dense, fixed-dimensional vectors in a high-dimensional space. The resulting embeddings capture semantic or contextual relationships, enabling efficient similarity comparisons, clustering, and information retrieval. For example, text embeddings generated from embeddings may be used to find semantically similar sentences, enhance search algorithms, or classify documents based on their content. Their versatility makes them fundamental in applications like recommendation systems, natural language processing tasks, and large-scale data analysis. As an example, the local cache selection/access control engine 110 may be hosted on a cloud server or allocated at a local device (e.g., such as the computing device 104).

In one aspect, the system 100b may include at least a computing device 104, a local cache selection/access control engine 110, and a LLM service provider network 142. The LLM service provider network 142 is a system of interconnected resources and platforms designed to deliver LLM-based capabilities to users and businesses. It typically includes cloud infrastructure for hosting and running the models, application programming interfaces (APIs) for seamless integration with various applications, and tools for fine-tuning and customizing models to specific use cases. These networks often support scalability, allowing users to process massive data or handle spikes in demand. By leveraging distributed computing and optimization techniques, the network ensures efficient delivery of advanced language understanding, generation, and interaction capabilities to a wide range of industries, from customer support to content creation.

In some aspects, the local cache selection/access control engine 110 may include a query module 112, an embeddings module 114, a determination module 116, a LLM service module 118, an optional question generation module 120, an optional authentication module 122, an ECM 126, a training module 128, a main embedding model 132, and a local cache table 134.

The local cache selection/access control engine 110 is configured to cache inputs (e.g., queries) and outputs (e.g., responses) from the main embedding model 132 to prepare the ECM 126 to generate new custom embeddings. In addition, the local cache selection/access control engine 110 is configured to receive an input query to the main embedding model 132 and check if the local cache (e.g., cache table 134) contains embeddings for the input query. This provides a way to prepare the ECM 126 for generating custom embeddings when a main embedding model is temporary down or unavailable.

The main embedding model 132 is a type of machine learning model (MLM), often used in natural language processing (NLP) and other domains, which performs embedding generation by transforming data (e.g., text, images, or graphs) into a continuous vector space. These vectors (e.g., embeddings) represent the essential characteristics of the input data in a way that preserves semantic or structural relationships. The main goal of an embedding model is to make data more accessible for computation and analysis by encoding it into a numerical format that machine learning algorithms can work with.

The ECM 126 is a custom type of MLM model configured to generate custom embeddings when the main embedding model 132 is unavailable (e.g., being offline due to network issues, maintenance/repairs/updating, or cyberattack), fails to produce a result, or encounters issues like high latency or errors. In some aspects, the ECM 126 is smaller, faster, cheaper, and more precise than the main embedding model 132. The ECM 126 typically operates with simplified architecture or reduced computational requirements, ensuring that the system 100b remains operational under constrained conditions. The ECM 126 provides an alternative to the main embedding model 132 and may provide higher accuracy of LLM responses due to the ECM 126 being prepared using custom-trained embeddings for different subject matters.

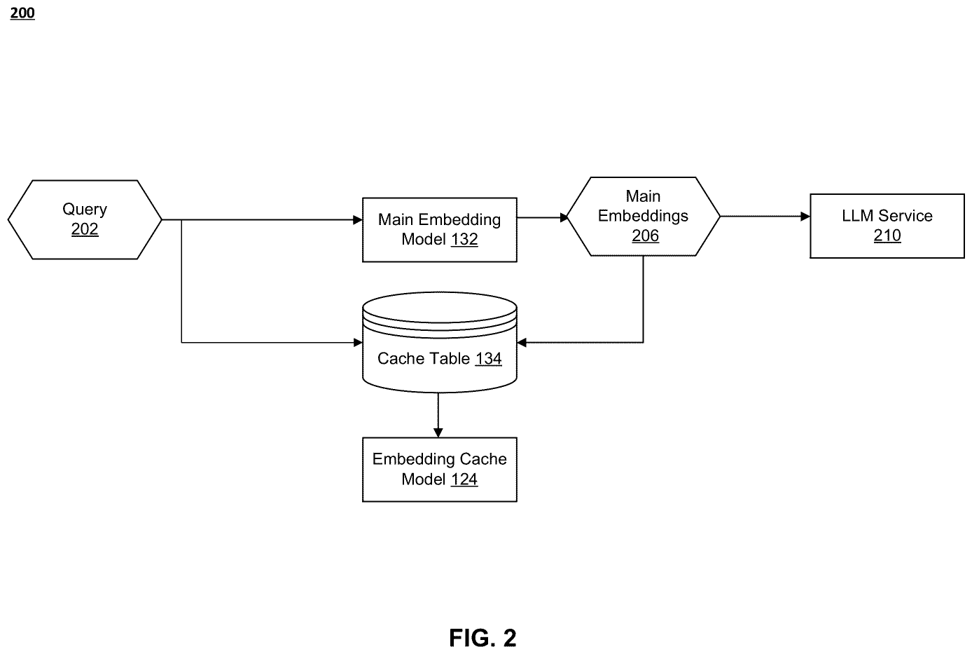

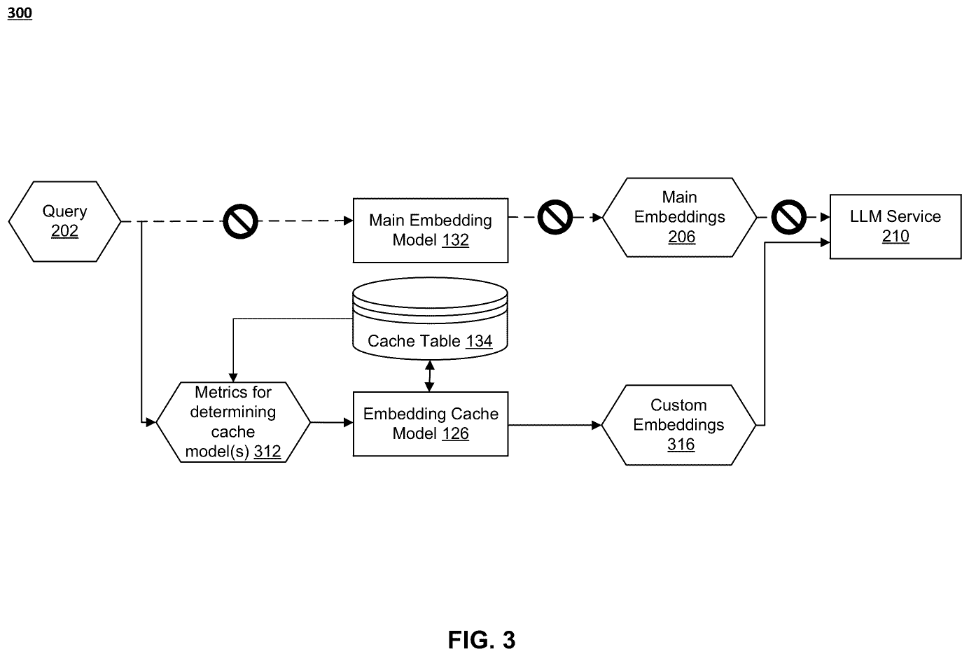

The computing device 104 may also execute a query module 112 configured to obtain a query (e.g., query 202 from FIG. 2, query 202 from FIG. 3) from a computing device 104 of a user. Generally, the query module 112 is configured to act as an intermediary layer in LLM-based systems by enhancing a LLM model's ability to understand, interpret, and respond to user queries effectively. Specifically, the query module 112 may be configured to handle and interpret the query and generate a prompt from the query that is formatted in a way that a LLM from the LLM service provider network 142 can process. The primary role of the query module 112 is to bridge the gap between raw user input from the computing device 104 and the LLM service provider network 142. In some aspects, the query module 112 may be equipped with natural language understanding for analyzing and interpreting the query to understand its intent, context, and meaning.

As an example, a user may use the computing device 104 to enter the query for input as a prompt into the LLM. In some aspects, the query module 112 may prepare the query as a prompt for input into the LLM on the LLM service provider network 142 by cleaning and normalizing the text. As a non-limiting example, this may involve: removing unnecessary punctuations, special characters, or stop words; correcting spelling or grammatical errors; or converting different forms of data (e.g., dates, numbers, or units) into a standardized format. By identifying the user's intent behind the query (e.g., asking a question, requesting information, or performing a task), the query module 112 ensure that the LLM from the LLM service provider network 142 may determine the appropriate type of response or action.

The computing device 104 may execute a embeddings module 114 configured to generate a main embedding by the main embedding model 132 based on an input query. In some aspects, the computing device 104 may also execute the embeddings module 114 configured to generate custom embeddings by the ECM 126. As mentioned above, generating main embeddings based on an input query is crucial for leveraging LLMs because embeddings distill semantic meaning into high-dimensional vector space, enabling efficient information retrieval and contextual understanding. These embeddings allow the embeddings to compare, classify, and rank related concepts with precision, bridging gaps in natural language nuances. By encoding the input query, embeddings facilitate tasks like document similarity, personalized recommendations, or fine-tuning workflows, enhancing the model's adaptability to user intent and improving overall performance across diverse applications.

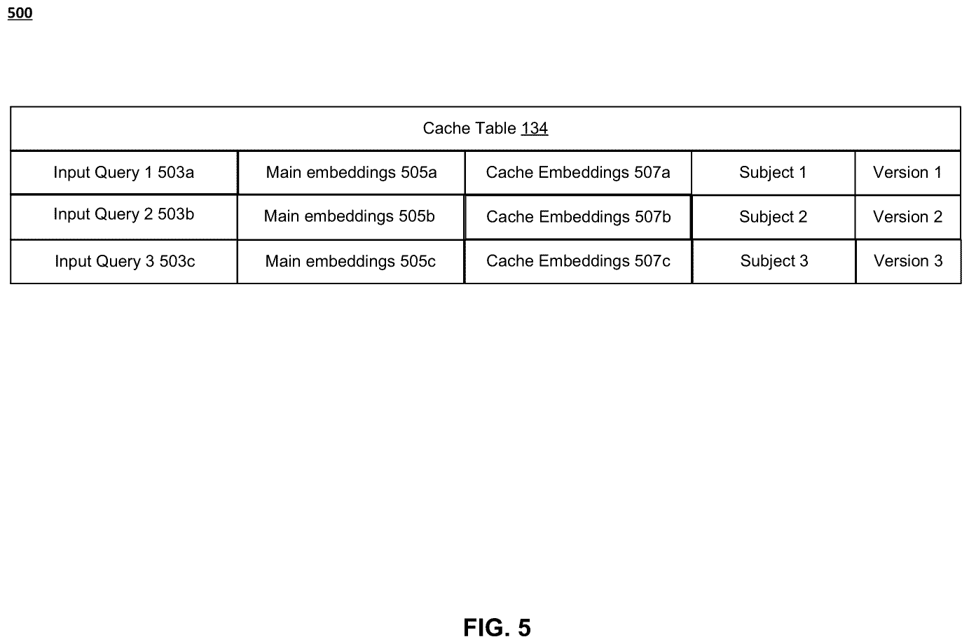

In some aspects, the computing device 104 may execute the embeddings module 114 to store an input query and main embeddings as corresponding entries in the cache table 134 or store the input query, the main embedding, and custom embeddings as corresponding entries in the cache table 134, as will be shown in more detail in FIG. 5. Storing input queries and their corresponding main embeddings in a local cache table 134 is highly beneficial for improving system efficiency and scalability. In some aspects, the computing device 104 may execute the embeddings module 114 to store additional custom embeddings for the one or more questions in additional cache tables 134. This approach allows for quick retrieval of embeddings for frequently used or similar queries, reducing redundant computations and lowering latency. By caching this data locally in the cache table 134, systems can handle repeated user requests or related queries more effectively, enabling real-time responsiveness. Additionally, it optimizes resource utilization, minimizes costs associated with recomputing embeddings, and provides a foundation for analyzing patterns in user interactions, leading to more personalized and context-aware services.

In some aspects, the computing device 104 may execute the embeddings module 114 to search the cache table 134 using a LLM and determine whether the input query is found in the cache table 134 within a query similarity threshold. This process enables the system 100b to identify semantically similar queries rather than relying solely on exact matches, leveraging the power of embeddings to account for nuanced language variations. By doing so, the system 100b can quickly retrieve relevant cached embeddings, improving response times and ensuring consistent handling of similar queries. This enhances the efficiency and intelligence of the system 100b, reducing redundant computations while maintaining the ability to deliver contextually accurate results.

In some aspects, the computing device 104 may execute the embeddings module 114 to identify a subject matter corresponding to the input query, select a respective cache table 134 associated with the subject matter, and determine whether the input query is found in the selected cache table 134 associated with the subject matter for the input query. This functionality of identifying the subject matter of an input query, selecting a corresponding cache table 134, and determining whether the query exists in that cache is particularly useful for improving efficiency and accuracy in subject-specific contexts. By organizing cache tables 134 based on subject matter, the system can narrow its search scope, reducing computational overhead and accelerating query processing. This targeted approach ensures that results are retrieved from the most relevant cache, enhancing precision and relevance in response generation. Additionally, it supports scalability by enabling effective management of large, domain-specific datasets while maintaining system performance and user experience.

In some aspects, the computing device 104 may execute the embeddings module 114 to transmit a custom embedding corresponding to a main embedding in the cache table 134. Transmitting a custom embedding corresponding to a main embedding in the cache table 134 is valuable for enabling flexible and tailored downstream applications. By providing a custom embedding, the system 100b can adapt the representation to meet specific contextual or functional requirements, such as aligning with the preferences of a client application or optimizing for a particular task. This capability ensures that the embeddings not only capture the original semantic essence but also fit seamlessly into varied use cases, improving interoperability and enhancing the precision and utility of the system's responses.

The computing device 104 may execute a determination module 114 configured to search for an input query or a generated main embeddings in the cache table 134. In addition, the determination module 114 may be configured to determine whether a number of entries in the cache table 134 is less than a predetermined threshold for training the ECM 126. This functionality of the determination module 114 to search for an input query or generated main embeddings in the cache table 134 and assess whether the number of entries is below a threshold for training the ECM 126 is critical for maintaining system efficiency and adaptability. By monitoring the cache table's size, the system 100b ensures that there is sufficient data for meaningful training of the ECM 126 without overloading resources. This approach optimizes the balance between leveraging historical data and maintaining the cache's relevance, supporting effective training and ensuring the system remains responsive and scalable for dynamic query processing needs.

The computing device 104 may execute the LLM service module 118 configured to interact with the LLM service provider network 142 by transmitting a prompt generated by the query module 112 for input into the LLM from the LLM service provider network 142 and to obtain responses from the LLM service provider network 142. Generally, the LLM service module 118 is responsible for managing the interactions between the LLM service provider network 142 and modules from the local cache selection/access control engine 110. The primary function of the LLM service module 118 is to handle the exchange of data between the local cache selection/access control engine 110 and the LLM service provider network 142 to ensure that the inputs and output of the LLM are effectively communicated to the appropriate destinations. This module serves as the interface layer that facilitates communication to enable the LLM service module 118 to integrate into the system 100b.

In some aspects, the LLM service module 118 is configured to provide an API that the local cache selection/access control engine 110 utilizes to interact with the LLM service provider network 142. As a non-limiting example, this may include handling API requests and responses from the LLM service provider network 142, managing authentication and authorization for secure access, or supporting different API protocols (e.g., REST, WebSocket) to accommodate various integration needs.

In some aspects, the LLM service module 118 may be configured to integrate with internal and/or external systems and databases such as the cache table 134. This may involve fetching additional data needed to answer a query or enabling bidirectional communication between the LLM service module 118 and external systems (e.g., CRM software, knowledge bases, or real-time data feeds). More details about the function and contents of the cache table 134 will be shown in FIG. 5.

The computing device 104 may execute the optional question generator module 120 configured generate one or more questions related to the input query. In some aspects, a LLM may be utilized to analyze the input query and generate one or more questions to obtain variations of the input query for specific topics. In addition, the optional question generator module 120 may also be configured to store answers corresponding to the one or more questions.

The computing device 104 may execute the optional authentication module 122 configured to determine whether a user is authorized to access the cache table 134 such that the cache table 134 is only accessible to authorized users. This mechanism protects sensitive information stored in the cache table 134 by restricting access to only authorized users, mitigating the risk of unauthorized data exposure or misuse. By implementing such safeguards, the system 100b upholds compliance with data protection regulations and reinforces trust among users, while also maintaining the integrity and confidentiality of cached embeddings and related data.

The computing device 104 may execute the training module 128 configured to prepare (e.g., train) the ECM 126 by obtaining a plurality of input queries to the LLM service from the LLM service provider network 142, obtaining corresponding main embeddings for the input query from the LLM service, and training the ECM 126 to generate embeddings using knowledge distillation based on the plurality of input queries and the corresponding main embeddings.

Training the ECM 126 involves using the training module 128 to gather a diverse set of input queries from the LLM service provider network 142 and their corresponding main embeddings generated by the LLM service. The ECM 126 is then trained using knowledge distillation, a process where the ECM 126 learns to replicate the embedding-generation capabilities of the LLM. This training is crucial because it enables the ECM 126 to independently generate high-quality embeddings, reducing dependency on the LLM for every query and significantly improving efficiency and scalability. By embedding knowledge from the LLM into the ECM 126, the system 100b can process queries faster, handle larger workloads, and operate with reduced computational and latency costs, all while maintaining embedding accuracy and relevance.

It should be noted that the generation of embeddings of the main embedding model 132 and/or the ECM and the implementation and preparation of the ECM 126 described in the present disclosure are heavily simplified. One skilled in the art will appreciate that the embeddings utilized may have significantly large datasets with highly specific details. This type of analysis would be beyond the capabilities of the human mind because the amount of data to be identified, considered, and processed is unfathomable.

FIG. 2 is a block diagram illustrating a system for executing a main embedding model while training the ECM according to aspects of the present disclosure.

Generally, when using embedding techniques for information retrieval, embeddings are created for queries-the queries (e.g., any form of text input including documents, images, audio, video, etc.) are embedded beforehand to build a searchable index, while the query 202 is then converted into an embedding to compare against the query embeddings and to find the most relevant results based on semantic similarity. When a user submits an input query 202, it is converted into an embedding vector to facilitate comparison with the query embeddings in the database. Both types of embeddings are needed because by using embeddings, queries that are semantically similar to a previous query may be found in a cache table 134 even if they do not contain the exact keywords. Accordingly, once queries are pre-embedded, searching for relevant queries becomes much faster by comparing the query embeddings against a large set of query embeddings.

As shown in system 200, a main embedding model 132 (e.g., the main embedding model 132 shown in FIG. 1b) processes the input query 202 (e.g., a few words, a sentence, a paragraph or a document) to generate a main embeddings 206 of the input query 202. The main embedding model 132 may be any commercial embedding training model. In some aspects, the main embedding model 132 can be a machine learning model or an algorithm. In some aspects, the main embedding model 132 is provided by or associated with the LLM service 210 and provides embeddings in a “native” dimensionality of the LLM. “Native” dimensionality implies that the embedding vectors produced by the LLM model matches the dimensional requirements or preferences of the associated LLM service 210. Using the native dimensionality ensures optimal performance as the embeddings are tailored to work seamlessly with the LLM without the need for additional transformations or dimensionality reductions.

Specifically, the main embedding model 132 processes the input query 202 by transforming its content into a dense numerical representation (e.g., embeddings) within a high-dimensional vector space. This transformation captures semantic relationships between words, phases, or entire sections of the input query 202. The main embedding model 132 typically tokenizes the text into smaller components, such as words or sub-words, and maps these to vectors using learned parameters. By aggregating these vectors, the main embedding model 132 creates a holistic embedding for the input query 202 that encodes its meaning, context, and structure. These embeddings can then be used for downstream tasks such as inference, dictionary building, similarity comparison and clustering.

The LLM from a LLM service 210 then uses the main embeddings 206 from the main embedding model 132 as a foundational mechanism to understand and process textual data effectively. The main embeddings 206, which are dense numerical vectors representing words, phrases, or entire documents, serve as a encoding that captures the semantic meaning and contextual relationships in the queries 202. In particular, the LLM service 210 uses main embeddings 206 to perform inference and respond to the queries 202. The main embeddings 206 also help group similar texts or classify them into predefined categories based on their proximity in the embedding space.

The cache table 134 is configured to cache the inputs (e.g., queries) and outputs (e.g., responses) of the main embeddings 206 to train the ECM 126. Specifically, the query 202, the main embedding 206, and the versions of the main embedding model 132 are also stored individually into the cache table 134, as shown in FIG. 5. The versions of the main embedding model 132 help in determining embeddings because different embeddings may have different format of embeddings. In some aspects, the cache table 134 contains replicated data (e.g., the inputs and outputs of the main embedding model 132), which reduces the cost of generating embeddings using an ECM 126 to the LLM service 210. In some aspects, the cache table 134 may also store a determined subject matter for the query 202.

The ECM 126 may be trained by distillation (e.g., surrogate modeling) using at least the query 202, the main embeddings 206, and corresponding versions of a main embedding model stored in the cache table 134 to generate new custom embeddings. In addition to being smaller, faster, cheaper, and more precise than the main embedding model 132, the ECM 126 may generate more precise custom embeddings for the LLM service 210. In particular, the ECM 126 differ from the main embedding models 132 because the ECM are tailored to specific vocabulary, context, and nuances of a particular domain or application. In this way, the ECM may allow for higher accuracy of queries, which leads to better accuracy of LLM responses. For example, there may be a custom ECM 126 trained for different subjects (e.g., chemistry, biology, economics, computer science, astronomy, etc.) or customer-specific embeddings based on confidential and/or business data for customers. The ECM 126 may be used when the main embedding model 132 is not available or accessible (e.g., see more detail in FIG. 3) to generate embeddings.

Training by distillation (e.g., surrogate modeling), particularly in the context of large language models (LLMs) and their embeddings, involves creating a more efficient “student” model (e.g., the ECM 126) that replicates the performance of a larger, more complex “teacher” model (e.g., the main embedding model 132). This process is helpful for deploying LLMs in environments where computational resources are limited, such as mobile devices or edge computing platforms. The distillation process focuses on transferring the knowledge embedded in the “teacher” model's parameters and outputs to the “student” model, allowing it to approximate the teacher's capabilities with significantly reduced computational overhead. This approach is particularly useful when the “teacher” model is computationally expensive to evaluate or deploy, such as in the case of a large neural network or complex simulation model. The goal is to create a “student” model that maintains the performance and accuracy of the “teacher” model while being more efficient in terms of computation and resource usage.

The process of distillation involves transferring knowledge from the “teacher” model to the “student” model. This is achieved by using the outputs of the main embedding model 132 (e.g., feature representations) as soft targets for training the ECM 126. By learning from these soft targets, the ECM 126 can capture the nuanced decision boundaries and generalization capabilities of the main embedding model 132, even with a reduced complexity. This method not only helps in compressing models for deployment on resource-constrained devices, but also aids in improving the interpretability and scalability of machine learning solutions.

In this way, the ECM 126 may be trained while the main embedding model 132 is being executed.

FIG. 3 is a block diagram illustrating a system for executing the EMC to generate custom embeddings when the main embedding model is unavailable according to aspects of the present disclosure. The method 300 describes an “economy” or “emergency” scenario, where the ECM 126 is used to generate custom embeddings based on the query 202 when the main embedding model 132 is offline or temporarily unavailable. As explained in FIG. 2, the ECM 126 may produce higher accurate responses based on the query 202 since the ECM 126 are custom trained for different subjects or customer-specific embeddings.

First, the method 300 includes determining that the main embedding model 132 is unavailable to generate main embeddings 206 or a user does not want to use the main embedding model 132 for embedding generation. Instead of using the main embeddings 206, the method 300 describes generating custom embeddings 316 for the LLM service 210 using the ECM 126.

At 312, the method 300 includes comparing the query 202 with queries from the cache table 134 based on similarity metrics to determine cache model(s). In some aspects, the similarity metrics for deciding subject matters in the queries may include computing average distance (e.g., dot product) between two vectors (e.g., the input and output vectors of the embeddings) stored in the cache table 134. In some aspects, a version of the main embedding model 132 may be considered when determining the similarity metric to the changes in format (e.g., different vector numbers) of different embeddings.

The method 300 then includes generating a custom embedding 316 by the ECM 126 based on the query 202. In some aspects, the method 300 may include searching cache table 134 for a main embeddings associated with the generated custom embedding 316 based on vector distance and transmitting the custom embedding 316 corresponding to a main embedding 206 from the cache table 134 to the LLM service 210.

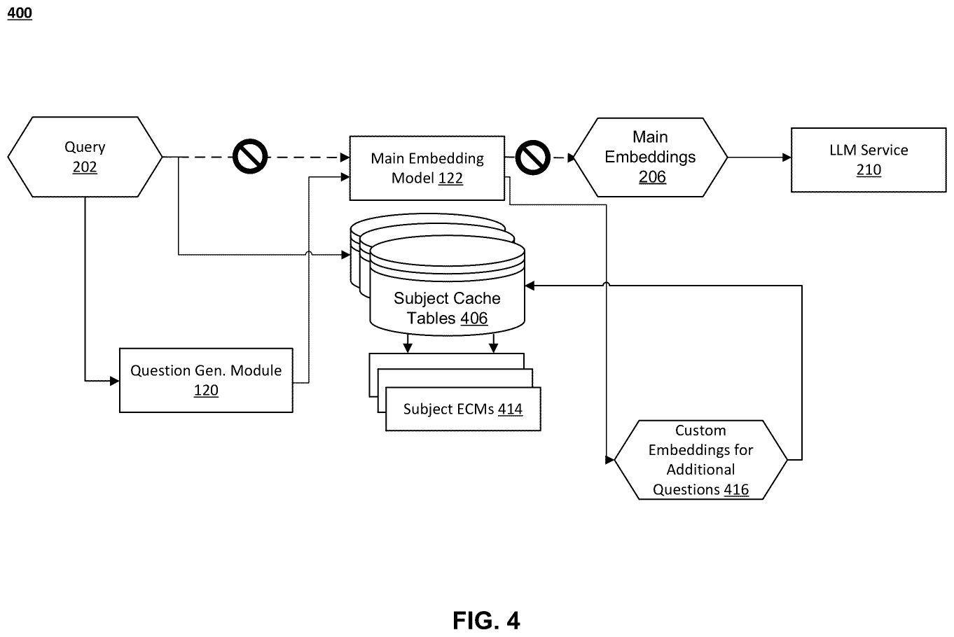

FIG. 4 is a block diagram illustrating a system for providing additional information for training the EMC according to aspects of the present disclosure. The method 400 describes obtaining variations of the query 202 for specific topics to train the subject ECMs 414 (e.g., different ECMs 124). In this way, not only is the query 202 saved into a respective subject cache tables 406, but also additional questions related to the query 202. This is particularly helpful when the query 202 does not match any info in the cached data (e.g., cache table 134) since there is a probability that the query 202 may match the additional questions or be closer to the additional questions.

The optional question generation module 120 is configured to generate additional questions to the user to obtain different variations of the query for specific topics. In this way, more relevant embeddings (e.g., custom embeddings for additional questions 416) may be generated and stored into respective subject cache tables 406. The custom embeddings for additional questions 416 may then be used to train the respective subject ECMs 414.

FIG. 5 is an example of a local cache table according to aspects of the present disclosure. Example 500 shows a cache table 134 is a local cache that contains replicated data (e.g., inputs and outputs) from the main embedding model 132. As shown in example 500, the cache table 134 may include at least a first column for storing input queries 503a, 503b, 503c, a second column for storing main embeddings 505a, 505b, 505c generated by a main embedding model, a third column for storing cache embeddings 507a, 507b, 507c generated by an ECM, a fourth column for storing subject matter determined for the input query, and a fifth column for storing version information of the main embedding model.

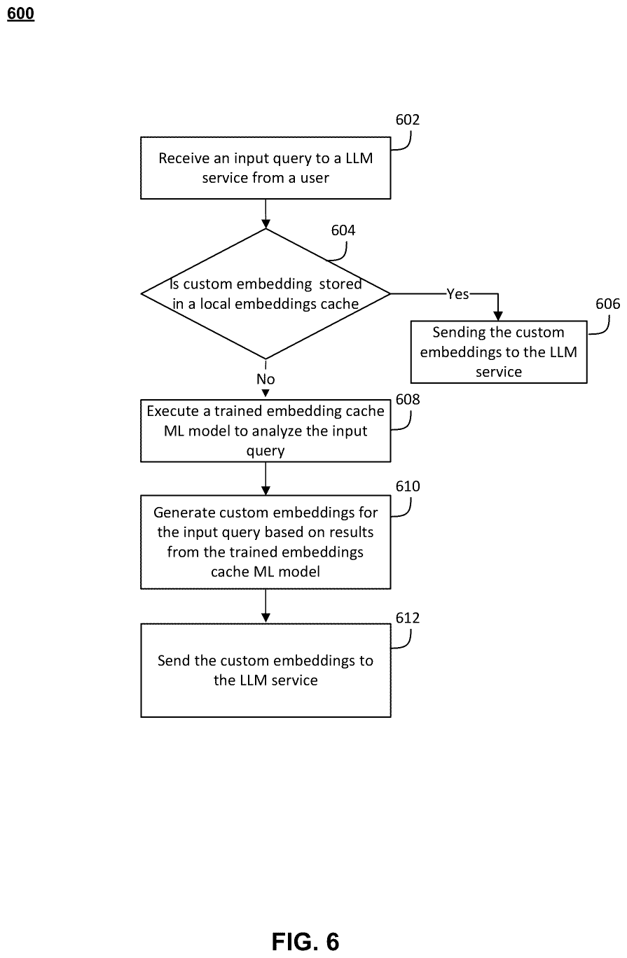

FIG. 6 is an example method for generating custom LLM embeddings according to aspects of the present disclosure. In various implementations, the method 600 is performed by a device with one or more processors and non-transitory memory that performs intent prediction. In some implementations, the method 600 is performed by processing logic, including hardware, firmware, software, or a combination thereof. In some implementations, the method 600 is performed by a processor executing code stored in a non-transitory computer-readable medium (e.g., a memory). The method 600 describes a method for generating custom LLM embeddings.

At 602, the method 600 may include receiving an input query to a LLM service from a user.

At 604, the method 600 may include determining whether custom embeddings for the input query are stored in a cache table, wherein the cache table is defined by at least a first column corresponding to input queries, a second column corresponding to main embeddings generated from the main embedding model, and a third column corresponding to custom cache embeddings generated from a prepared embeddings cache model (ECM).

In some aspects, determining whether the custom embeddings for the input query are stored in a local embeddings cache further comprises utilizing a LLM to search the local embeddings cache.

Based on a determination that the custom embeddings for the input query are stored in the cache table, at 606, the method 600 may include sending the custom embeddings from the cache table to the LLM service.

Based on a determination that the custom embeddings for the input query are not stored in the cache table, at 608, the method 600 may include executing a prepared ECM to analyze the input query.

At 610, the method 600 may include generating custom embeddings for the input query based on results from prepared ECM.

At 612, the method 600 may include transmitting the custom embeddings.

In some aspects, the method 600 may include storing the generated custom embeddings in the cache table.

In some aspects, the cache table comprises a plurality of separate subject-based local embedding caches such that each subject cache comprises custom embeddings associated with different subject of input queries.

In some aspects, determining whether custom embeddings for the input query are stored in the cache table further comprises: determining a subject matter corresponding to the input query; and determining whether custom embeddings associated with the subject matter for the input query are stored in the cache table.

In some aspects, the method 600 may include training the ECM by: obtaining a plurality of input queries to the LLM service, obtaining corresponding embeddings for the input query, and training the prepared ECM to generate embeddings using knowledge distillation based on the plurality of input queries and corresponding embeddings.

In some aspects, the cache table is deployed on an enterprise server associated with an organization of the user, and the prepared ECM is provided by a third-party service.

In some aspects, the cache table is only accessible to authorized users.

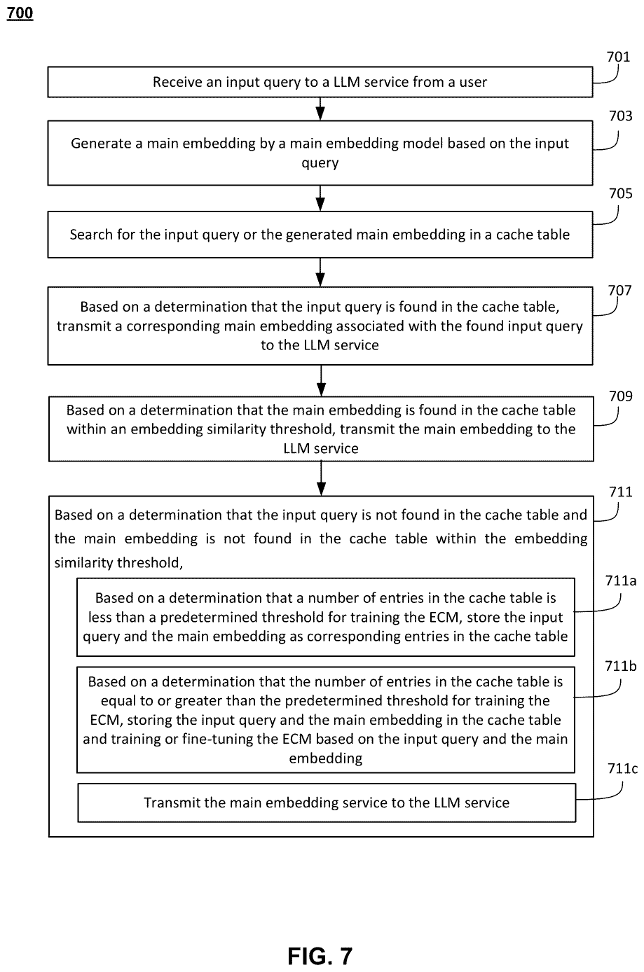

FIG. 7 is an example method for training an ECM according to aspects of the present disclosure. In various implementations, the method 700 is performed by a device with one or more processors and non-transitory memory that performs intent prediction. In some implementations, the method 700 is performed by processing logic, including hardware, firmware, software, or a combination thereof. In some implementations, the method 700 is performed by a processor executing code stored in a non-transitory computer-readable medium (e.g., a memory). The method 700 describes a method for training an ECM.

At 701, the method 700 may include receiving an input query to a LLM service from a user.

At 703, the method 700 may include generating a main embedding by a main embedding model based on the input query.

At 705, the method 700 may include searching for the input query or the generated main embedding in a cache table comprising at least a first column having input queries, a second column having main embeddings generated from the main embedding model, and a third column having cache embeddings generated from the ECM.

In some aspects, the cache table may include: at least a first column having input queries, a second column having main embeddings generated from the main embedding model, and a third column having cache embeddings generated from the ECM.

In some aspects, determining whether the input query is found in the cache table further comprises: searching the cache table for the input query using a LLM, and determining that the input query is found in the cache table within a query similarity threshold.

In some aspects, the cache table comprises a plurality of cache tables such that each cache table comprises custom embeddings associated with a respective subject matter. In some aspects, determining whether the input query is found in the cache table further comprises: identifying a subject matter corresponding to the input query, selecting a respective cache table associated with the subject matter, and determining whether the input query is found in the selected cache table associated with the subject matter for the input query.

In some aspects, determining whether the main embedding corresponds to an embedding in the cache table further comprises: identifying a subject matter corresponding to the input query; selecting a respective cache table associated with the subject matter; and determining whether the custom embeddings associated with the subject matter for the input query are stored in the cache table within the embedding similarity threshold.

In some aspects, the method 700 may include generating one or more questions corresponding to the input query; prompting the user, via a user interface, with the one or more questions; storing answers corresponding to the one or more questions; generating additional custom embeddings for the one or more questions; and storing the additional custom embeddings for the one or more questions in one or more additional cache tables.

At 707, the method 700 may include based on a determination that the input query is found in the cache table, transmitting a corresponding main embedding associated with the found input query to the LLM service.

At 709, the method 700 may include based on a determination that the main embedding is found in the cache table within an embedding similarity threshold, transmitting the main embedding.

In some aspects, the embedding similarity threshold is determined based on a similarity metric between distances of two or more embedding vectors.

At 711, the method 700 may include, based on a determination that the input query is not found in the cache table and the main embedding is not found in the cache table within the embedding similarity threshold, at 711a, based on a determination that a number of entries in the cache table is less than a predetermined threshold for training the ECM, storing the input query and the main embedding as corresponding entries in the cache table, at 711b, based on a determination that the number of entries in the cache table is equal to or greater than the predetermined threshold for training the ECM, storing the input query and the main embedding in the cache table and training or fine-tuning the ECM based on the input query and the main embedding, and, at 711c, transmitting the main embedding service to the LLM service.

In some aspects, the method 700 may further include based on the determination that the input query is found in the cache table or based on the determination that the main embedding is found in the cache table within the embedding similarity threshold, generating a custom embedding by the ECM based on the input query, and storing the input query, the main embedding, and the custom embedding as corresponding entries in the cache table.

In some aspects, the method 700 may include training the ECM by: obtaining a plurality of input queries to the LLM service; obtaining corresponding main embeddings for the input query from the LLM service; and training the ECM to generate embeddings using knowledge distillation based on the plurality of input queries and the corresponding main embeddings.

### In Some Aspects, the Method 700 May Include Determining Whether a user is authorized to access the cache table, wherein the cache table is accessible to authorized users only.

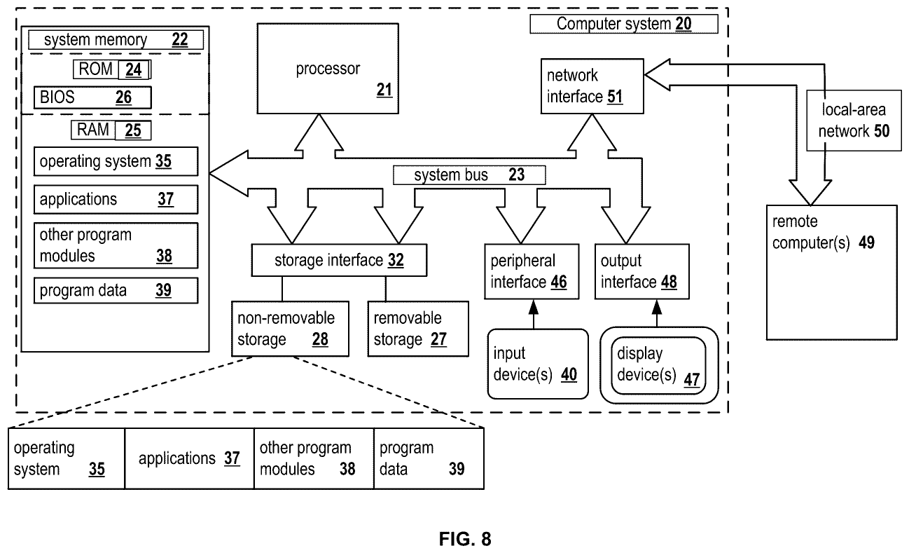

FIG. 8 is a block diagram illustrating a computer system 20 on which aspects of systems and methods for improving an ECM for custom LLMs may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for training an embeddings cache model (ECM), comprising:
receiving an input query to a large language model (LLM) service from a user;
generating a main embedding by a main embedding model based on the input query;
searching for the input query or the generated main embedding in a cache table;
based on a determination that the input query is found in the cache table, transmitting a corresponding main embedding associated with the found input query to the LLM service;
based on a determination that the main embedding is found in the cache table within an embedding similarity threshold, transmitting the main embedding to the LLM service; and
based on a determination that the input query is not found in the cache table and the main embedding is not found in the cache table within the embedding similarity threshold,
based on a determination that a number of entries in the cache table is less than a predetermined threshold for training the ECM, storing the input query and the main embedding as corresponding entries in the cache table,
based on a determination that the number of entries in the cache table is equal to or greater than the predetermined threshold for training the ECM, storing the input query and the main embedding in the cache table and training or fine-tuning the ECM based on the input query and the main embedding, and
transmitting the main embedding to the LLM service.

2. The method of claim 1, wherein the cache table comprises: at least a first column having input queries, a second column having main embeddings generated from the main embedding model, and a third column having cache embeddings generated from the ECM.

3. The method of claim 1, wherein determining whether the input query is found in the cache table further comprises:
searching the cache table for the input query using a LLM, and
determining that the input query is found in the cache table within a query similarity threshold.

4. The method of claim 1, wherein the embedding similarity threshold is determined based on a similarity metric between distances of two or more embedding vectors.

5. The method of claim 1, wherein the cache table comprises a plurality of cache tables such that each cache table comprises custom embeddings associated with a respective subject matter.

6. The method of claim 5, wherein determining whether the input query is found in the cache table further comprises:
identifying a subject matter corresponding to the input query,
selecting a respective cache table associated with the subject matter, and
determining whether the input query is found in the selected cache table associated with the subject matter for the input query.

7. The method of claim 5, wherein determining whether the main embedding corresponds to an embedding in the cache table further comprises:
identifying a subject matter corresponding to the input query;
selecting a respective cache table associated with the subject matter; and
determining whether the custom embeddings associated with the subject matter for the input query are stored in the cache table within the embedding similarity threshold.

8. The method of claim 7, further comprising:
generating one or more questions corresponding to the input query;
prompting the user, via a user interface, with the one or more questions;
obtaining main embeddings from main embeddings model for one or more answers from the user; and
storing the one or more answers from the user and the corresponding main embeddings in the cache table.

9. The method of claim 1, further comprising:
training the ECM by:
obtaining a plurality of input queries to the LLM service;
obtaining corresponding main embeddings for the input query from the LLM service; and
training the ECM to generate embeddings using knowledge distillation based on the plurality of input queries and the corresponding main embeddings.

10. The method of claim 1, further comprising:
determining whether a user is authorized to access the cache table, wherein the cache table is accessible to authorized users only.

11. A system for training an embeddings cache model (ECM), comprising:
at least one memory;
at least one hardware processor coupled with the least one memory and configured, individually or in combination, to:
receive an input query to a large language model (LLM) service from a user;
generate a main embedding by a main embedding model based on the input query,
search for the input query or the generated main embedding in a cache table,
based on a determination that the input query is found in the cache table, transmit a corresponding main embedding associated with the found input query to the LLM service,
based on a determination that the main embedding is found in the cache table within an embedding similarity threshold, transmit the main embedding to the LLM service, and
based on a determination that the input query is not found in the cache table and the main embedding is not found in the cache table within the embedding similarity threshold,
based on a determination that a number of entries in the cache table is less than a predetermined threshold for training the ECM, store the input query and the main embedding as corresponding entries in the cache table,
based on a determination that the number of entries in the cache table is equal to or greater than the predetermined threshold for training the ECM, store the input query and the main embedding in the cache table and train or fine-tune the ECM based on the input query and the main embedding, and
transmit the main embedding to the LLM service.

12. The system of claim 11, wherein the cache table comprises at least a first column having input queries, a second column having main embeddings generated from the main embedding model, and a third column having cache embeddings generated from the ECM.

13. The system of claim 11, wherein determining whether the input query is found in the cache table further comprises:
searching the cache table for the input query using a LLM, and
determining that the input query is found in the cache table within a query similarity threshold.

14. The system of claim 11, wherein the embedding similarity threshold is determined based on a similarity metric between distances of two or more embedding vectors.

15. The system of claim 11, wherein the cache table comprises a plurality of cache tables such that each cache table comprises custom embeddings associated with a respective subject matter.

16. The system of claim 15, wherein determining whether the input query is found in the cache table further comprises:
identifying a subject matter corresponding to the input query,
selecting a respective cache table associated with the subject matter, and
determining whether the input query is found in the selected cache table associated with the subject matter for the input query.

17. The system of claim 15, wherein determining whether the main embedding corresponds to an embedding in the cache table further comprises:
identifying a subject matter corresponding to the input query;
selecting a respective cache table associated with the subject matter; and
determining whether the custom embeddings associated with the subject matter for the input query are stored in the cache table within the embedding similarity threshold.

18. The system of claim 17, wherein the at least one hardware processor coupled with the at least one memory and configured, individually or in combination, to:
generate one or more questions corresponding to the input query;
prompt the user, via a user interface, with the one or more questions;
obtain the main embeddings from the main embeddings model for one or more answers from the user; and
store the one or more answers from the user and the corresponding main embeddings in cache table.

19. The system of claim 17, wherein the at least one hardware processor coupled with the at least one memory and configured, individually or in combination, to:
train the ECM by:
obtaining a plurality of input queries to the LLM service;
obtaining corresponding main embeddings for the input query from the LLM service; and
training the ECM to generate embeddings using knowledge distillation based on the plurality of input queries and the corresponding main embeddings.

20. A non-transitory computer readable medium storing thereon computer executable instructions for training an embeddings cache model (ECM), including instructions for:
receiving an input query to a large language model (LLM) service from a user;
generating a main embedding by a main embedding model based on the input query;
searching for the input query or the generated main embedding in a cache table;
based on a determination that the input query is found in the cache table, transmitting a corresponding main embedding associated with the found input query to the LLM service;
based on a determination that the main embedding is found in the cache table within an embedding similarity threshold, transmitting the main embedding to the LLM service; and
based on a determination that the input query is not found in the cache table and the main embedding is not found in the cache table within the embedding similarity threshold,
based on a determination that a number of entries in the cache table is less than a predetermined threshold for training the ECM, storing the input query and the main embedding as corresponding entries in the cache table,
based on a determination that the number of entries in the cache table is equal to or greater than the predetermined threshold for training the ECM, storing the input query and the main embedding in the cache table and training or fine-tuning the ECM based on the input query and the main embedding, and
transmitting the main embedding to the LLM service.
